(19) United States
(12) Patent Application Publication
(10) Pub. No.: US 2023/0330896 A1
(43) Pub. Date: Oct. 19, 2023

(54) DRY PELLETIZING PROCESS BY HIGH IMPACT AND COMPRESSION

(71) Applicant: Manuel Medina Cortes, Zapopan (MX)

(72) Inventor: Manuel Medina Cortes, Zapopan (MX)

(21) Appl. No.: 17/311,719

(22) Filed: Jun. 8, 2021

(30) Foreign Application Priority Data
Jul. 16, 2020 (WO) PCT/MX2020/007620

(51) Int. Cl. B29B 9/08

(52) U.S. Cl. CPC B29B 9/08

(57) ABSTRACT

The high impact and compression dry pelletizing process that the invention proposes focuses its novel characteristics on the fact of obtaining a unified mixture of olefins and conventional polyolefins, recycled plastics, new generation plastics, Biobased, bioplastics, mineral carbonates and/or organic and/or organic fibers and/or synthetic fibers for use in the plastic industry based on compression and temperature, thus achieving greater production capacity, as well as reducing times, materials and space, simplifying these steps by not requiring the tub of water, nor the cutter, in addition, to eliminate the high temperature to melt the materials and mix them and/or formulas.

The present invention refers to the process of dry pelletizing by high impact and compression, to obtain a unified mixture with materials such as conventional olefins and polyolefins, such as recycled plastics, new generation plastics, bio-based, bio-plastics, mineral and/or organic carbonates and/or organic fibers and/or synthetic fibers for use in the plastic industry, for the different types of procedures such as injection, extrusion, thermoforming, blowing and several other processes, thus achieving greater production capacity, as well as reducing production times, materials and space, simplifying the process without requiring the water tub for cooling, nor the cutter, in addition eliminating this way high temperatures and reducing the use of energy to melt the mixed materials and/or formulas.

### BACKGROUND

Currently the most common pelletizing system that everyone uses in the plastics industry is to melt the different materials by means of spindles with high temperature, and then take this mixture to a head where the same material comes out in a spaghetti-shaped form, once you have these hot lines of the unified material, it passes into a tub with water which cools the material and leaves it rigid ready for cutting, once cut into small pellets, these are packed for later marketing.

The recycling of plastics by means of pelletizing lines, the grain cut or formed once the plastic is solidified, however, through this Pelletizing line the grain is cut even when the plastic has not fully solidified this is a new form for plastic recycling by means of pelletizing. Unlike conventional methods, when the grain is cut once it is almost cold and in a state very close to solidification, the cutting or forming of the grain directly under water has several advantages.

Once the soft plastic material is cut and still in a fluidized state, it is immediately solidified with cold water, avoiding the generation of dust, obtaining a pellet on a regular form and facilitating the packaging and transport of the same.

Simultaneously performing the cooling phase with the cutting phase reduces from 4 to 5 m of space usually occupied by the cooling tub, considerably reducing the area occupied by the equipment.

The present invention has its field of application in the mechanical and chemical area as it provides a process to obtain a unified mixture for high impact pelletizing and compression for use in the plastics industry.

### DETAILED DESCRIPTION

To complement the description that is being made and with the aim of a better understanding of the characteristics of the invention are accompanied to this as an integral part of it, the following stages of this innovating dry pelletizing process by high impact and compression.

The process that the invention proposes focuses its novel characteristics on obtaining a unified mixture of conventional olefins and polyolefins, recycled plastics, next generation plastics, bio-based, bio-plastics, mineral and/or organic carbonates, natural and/or synthetic fibers for use in the plastic industry based on impact and compression, achieving greater production capacity, as well as reducing production times, materials savings, energy and space at the production site, simplifying these steps without requiring a tub of water for cooling, nor the cutter, in addition, to eliminating the process the high temperature and energy to melt the materials and mix them.

### PREFERRED EMBODIMENT OF THE INVENTION

The high impact and compression dry pelletizing process is performed by mixing the powdered materials in a high-speed mixer (turbomixer) according to the formulation required to obtain a homogeneous mixture of plastic materials, (Pe, pp, ps, pet, pla, pbta or any other commercial or engineering resin) they are mixed with natural and/or synthetic starches, natural and/or synthetic fibers or natural or synthetic additives or a mixture of all, obtaining a unified and mixed compound at high speed (mixture of lumps); This new compound is introduced to a hopper, in this case, it is required that the materials to be introduced is the mixture of lumps already unified or previously mixed by the high-speed mixer to the pelletizer by compression made lumps, from the hopper it passes to the rollers of high compression and speed, these rollers have the drawing in the desired way, in this case in the form of pellet or tablets, once the product passes through these rollers the (mixture of lumps) is compacted and exits the rollers in the form that they have, in this case, pellet or tablets.

Subsequently, once the pellet or tablet is obtained from the lump mixture and if required depending on the formula, it is sent by means of bands or gravity to a high temperature dryer which works either by electric energy, gas, biomass or other energy medium, once the dry pellet (mixture of lumps) leaves the dryer, it is packed in sacks, super bags or other selected packaging for storage and subsequent marketing.

With this process, the compressed pellet or tablet has the same functionality as the pellet of conventional processes, but with a great simplification in the reduction of inputs, space, personnel and costs.

With this new pelletizing process it can be performed with all types of Plastic and organic material, mainly PE (Polyethylene), PP (Polypropylene), PS (Polystyrene), PLA (Polylactic Acid), PBAT (Polybutylene adipate-co-terephthalate), PVC (Polyvinyl Chloride); Among many other plastic resins.

In Organic materials we can process, plastic materials with all kinds of natural fibers such as, wood fibers, rice fibers, corn fibers, sugarcane fibers, agave fibers in all its types, among many more fibers. In Mineral and organic materials we can process: CAC03 mineral carbonates, Organic carbonates Sea shells, among many others.

1. Dry pelletizing process due to high impact and compression, of the known pelletizing processes to obtain pellets or tablets for the plastic industry, characterized in that the process is dry due to high impact based on compression and temperature, greater pellet production capacity for use in injection, extrusion, thermoforming, blowing and several more.

2. Dry pelletizing process due to high impact and compression, as mentioned in claim 1 and characterized in that time, materials and spaces are reduced, by eliminating the steps of using the water tub, the cutter, in addition, to eliminate the high temperature to melt the materials and mixed.

3. Dry pelletizing process due to high impact and compression, as mentioned in claim 2 and characterized in that costs are reduced in materials and labor, this process being more practical and economical.

4. Dry pelletizing process due to high impact and compression, as mentioned in claim 3 and characterized in that energy consumption is reduced. being this process more practical and economical.
